(19) United States
(12) Patent Application Publication
(10) Pub. No.: US 2026/0245195 A1
(43) Pub. Date: Aug. 20, 2026

(54) TEXTURE IMAGE ACQUISITION METHOD, TEXTURE IMAGE ACQUISITION APPARATUS, AND PROGRAM

(71) Applicant: SEIKO EPSON CORPORATION, TOKYO (JP)

(72) Inventors: Mitsuhiro YAMASHITA, MATSUMOTO-SHI (JP); Takahiro KAMADA, MATSUMOTO-SHI (JP); Yuko YAMAMOTO, SHIOJIRI-SHI (JP); Takuya ONO, SHIOJIRI-SHI (JP)

(21) Appl. No.: 19/433,152

(22) Filed: Dec. 26, 2025

(30) Foreign Application Priority Data
Dec. 26, 2024 (JP) 2024-229784

(51) Int. Cl. G06T 7/00; G06T 7/90

(52) U.S. Cl. CPC G06T 7/0004; G06T 7/90; G06T 2207/30124; G06T 2207/30144

(57) ABSTRACT

A texture image acquisition method includes: providing a backing having a first backing color area and a second backing color area, and a fabric having a printed area where ink is printed and a non-printed area where the ink is not printed; imaging the fabric with the backing superimposed thereon in a way that four partial areas below are provided, (i) a first partial area where the first backing color area and the non-printed area are superimposed on each other, (ii) a second partial area where the second backing color area and the non-printed area are superimposed on each other, (iii) a third partial area where the first backing color area and the printed area are superimposed on each other, and (iv) a fourth partial area where the second backing color area and the printed area are superimposed on each other to acquire a captured image; and clipping a selected partial area from a fabric image to acquire texture image data.

The present application is based on, and claims priority from JP Application Serial Number 2024-229784, filed Dec. 26, 2024, the disclosure of which is hereby incorporated by reference herein in its entirety.

### BACKGROUND

### 1. Technical Field

The present disclosure relates to a texture image acquisition method, a texture image acquisition apparatus, and a program.

### 2. Related Art

In the technology described in JP-A-2001-143085, the light transparency of a transparent object is quantified based on an image obtained by imaging the transparent object in a state in which a board having a black-and-white pattern is disposed behind the transparent object.

JP-A-2001-143085 is an example of the related art.

There is a known technology for creating a proof image showing a printed fabric that is a fabric on which an image is printed. In the proof image showing the printed fabric, it is required to reproduce the texture of the fabric, which is a recording medium. In the technology described in JP-A-2001-143085, light transparency is considered, but the degree of ink absorption is not considered. There is therefore room for further improvement in the technology for acquiring information on the texture of a fabric.

### SUMMARY

The present disclosure can be implemented in the aspects below.

According to a first aspect of the present disclosure, a texture image acquisition method is provided. The texture image acquisition method includes: (a) providing an imaging jig having a window through which light passes, and a backing having at least a first backing color area and a second backing color area; (b) providing a fabric having a printed area where ink is printed, and a non-printed area where the ink is not printed; (c) superimposing the fabric on the backing in a way that four partial areas below are provided, (i) a first partial area where the first backing color area of the backing and the non-printed area of the fabric are superimposed on each other, (ii) a second partial area where the second backing color area of the backing and the non-printed area of the fabric are superimposed on each other, (iii) a third partial area where the first backing color area of the backing and the printed area of the fabric are superimposed on each other, and (iv) a fourth partial area where the second backing color area of the backing and the printed area of the fabric are superimposed on each other; (d) superimposing the imaging jig on the fabric in a way that the first partial area, the second partial area, the third partial area, and the fourth partial area fall within the window of the imaging jig; (e) after (d) is carried out, imaging the fabric together with the imaging jig to acquire a captured image; (f) selecting at least one of the first partial area, the second partial area, the third partial area, and the fourth partial area as a target to be clipped from a fabric image contained in the captured image; and (g) clipping the selected partial area from the fabric image to acquire texture image data.

According to a second aspect of the present disclosure, a texture image acquisition apparatus is provided. The texture image acquisition apparatus includes: an imager configured to image a fabric together with an imaging jig to acquire a captured image, the fabric having a printed area where ink is printed and a non-printed area where the ink is not printed together with an imaging jig having a window through which light passes: in a state in which the fabric is superimposed on a backing having at least a first backing color area and a second backing color area in a way that four partial areas below are provided, (i) a first partial area where the first backing color area of the backing and the non-printed area of the fabric are superimposed on each other, (ii) a second partial area where the second backing color area of the backing and the non-printed area of the fabric are superimposed on each other, (iii) a third partial area where the first backing color area of the backing and the printed area of the fabric are superimposed on each other, and (iv) a fourth partial area where the second backing color area of the backing and the printed area of the fabric are superimposed on each other; and in a state in which the imaging jig is superimposed on the fabric in a way that the first partial area, the second partial area, the third partial area, and the fourth partial area fall within the window of the imaging jig; a selector configured to select at least one of the first partial area, the second partial area, the third partial area, and the fourth partial area as a target to be clipped from a fabric image contained in the captured image; and a clipper configured to clip the selected partial area from the fabric image to acquire texture image data.

According to a third aspect of the present disclosure, a program that acquires a texture image is provided. A program configured to cause a computer to achieve: the function of imaging a fabric having a printed area where ink is printed and a non-printed area where the ink is not printed together with an imaging jig having a window through which light passes to acquire a captured image in a state in which the fabric is superimposed on a backing including at least a first backing color area and a second backing color area in a way that four partial areas below are provided, (i) a first partial area where the first backing color area of the backing and the non-printed area of the fabric are superimposed on each other, (ii) a second partial area where the second backing color area of the backing and the non-printed area of the fabric are superimposed on each other, (iii) a third partial area where the first backing color area of the backing and the printed area of the fabric are superimposed on each other, and (iv) a fourth partial area where the second backing color area of the backing and the printed area of the fabric are superimposed on each other, and in a state in which the imaging jig is superimposed on the fabric in a way that the first partial area, the second partial area, the third partial area, and the fourth partial area fall within the window of the imaging jig; the function of selecting at least one of the first partial area, the second partial area, the third partial area, and the fourth partial area as a target to be clipped from a fabric image contained in the captured image; and the function of clipping the selected partial area from the fabric image to acquire texture image data.

### BRIEF DESCRIPTION OF THE DRAWINGS

FIG. 1 is a block diagram showing a schematic configuration of a texture image acquisition apparatus according to an embodiment of the present disclosure.

FIG. 2 illustrates an imaging method in the present embodiment.

FIG. 3 illustrates an example of a captured image.

FIG. 4 is a flowchart showing the process of acquiring texture image data.

FIG. 5 illustrates a method for identifying a range to be clipped.

FIG. 6 illustrates a guide marker.

FIG. 7 illustrates a configuration in which an imaging jig and a backing are fixed to each other.

FIG. 8 illustrates a case where the imaging jig is provided with a positioning mark.

FIG. 9 illustrates imaging using a backing having three backing color areas.

FIG. 10 illustrates imaging using a fabric having two printed areas.

FIG. 11 illustrates imaging using a backing having three backing color areas and a fabric having two printed areas.

FIG. 12 illustrates brightness correction.

### DESCRIPTION OF EMBODIMENTS

### A. Embodiment

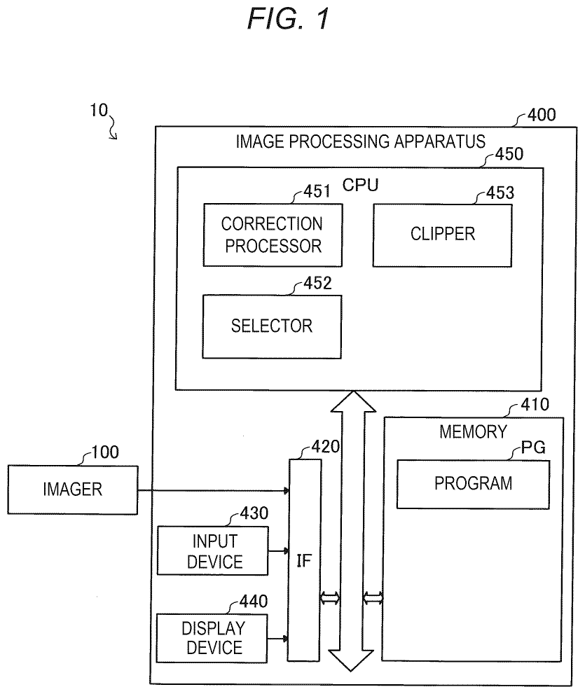

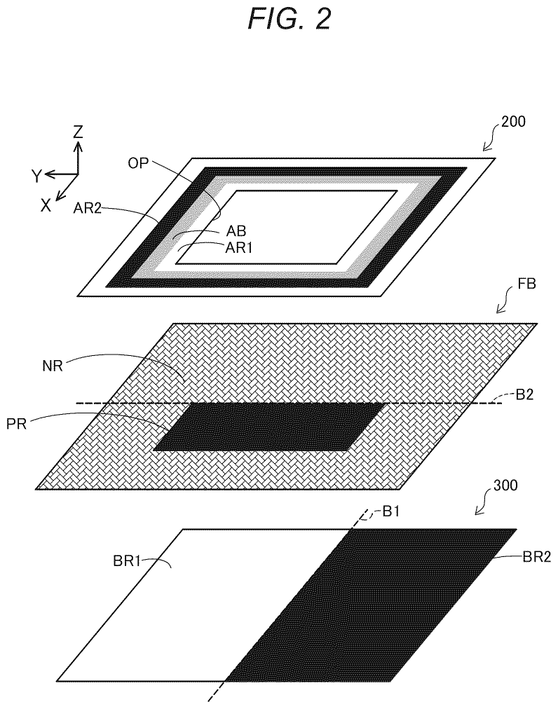

FIG. 1 is a block diagram showing a schematic configuration of a texture image acquisition apparatus 10 according to an embodiment of the present disclosure. FIG. 2 illustrates an imaging method in the present embodiment. The texture image acquisition apparatus 10 acquires a texture image by using an image obtained by imaging a subject having a texture. In the present embodiment, the subject is a fabric FB. The acquired texture image is used, for example, when a proof image is generated in textile printing using the fabric FB as a print medium, in the process of adding a texture to the proof image to reproduce the texture of the fabric FB in the proof image.
The texture image acquisition apparatus 10 includes an imager 100, an imaging jig 200 (see FIG. 2), a backing 300 (see FIG. 2), which is a backing member, and an image processing apparatus 400. Note that FIG. 1 shows neither the imaging jig 200 nor the backing 300.

The imager 100 (see FIG. 1) is, for example, a camera and images the fabric FB. The imager 100 is communicatively connected to the image processing apparatus 400 in a wired or wireless manner. The imager 100 transmits the captured image to the image processing apparatus 400. For example, the imager 100 may be fixed by using a stand coupled to a placement table at which a subject is placed, as the imager described in JP-A-2024-116006 (hereinafter referred to as prior application 1) filed by the applicant of the present disclosure. The fabric FB is imaged by the imager 100 in a state in which the imaging jig 200 is superimposed on the fabric FB backed with the backing 300, as shown in FIG. 2.

The imaging jig 200 can be the imaging jig described in the prior application 1. The imaging jig 200 is configured, for example, with a thin metal plate, a synthetic resin sheet, or a thick paper sheet. A window OP, which is a quadrangular opening, is provided at the center of the imaging jig 200. Three areas are provided around the window OP. A first area AR1, a buffer area AB, and a second area AR2 are provided around the window OP. The first area AR1, the buffer area AB, and the second area AR2 constitute a comparison pattern used to correct the brightness of the captured image.

The first area AR1 is disposed so as to surround the window OP. The first area AR1 is a hollow quadrangle, and the outer peripheral shape thereof is configured as a quadrangle concentric with the window OP. The color of the first area AR1 is white. For example, a measured value as a result of measurement of the brightness of the first area AR1 under a standard light source is stored in a memory 410 in advance.

The buffer area AB is provided outside the first area AR1. The buffer area AB is disposed so as to surround the first area AR1. The buffer area AB is a hollow quadrangle, and the outer peripheral shape thereof is configured as a quadrangle concentric with the window OP. The color of the buffer area AB is gray. Note that the comparison pattern may not include the buffer area AB.

The second area AR2 is provided outside the buffer area AB. The second area AR2 is disposed so as to surround the buffer area AB. The second area AR2 is a hollow quadrangle, and the outer peripheral shape thereof is configured as a quadrangle concentric with the window OP. The color of the second area AR2 is black. For example, a measured value as a result of measurement of the brightness of the second area AR2 under the standard light source is stored in the memory 410 in advance. An area having a ground color of the imaging jig 200 may be present outside the second area AR2.

In the present embodiment, the fabric FB is imaged in a state in which the imaging jig 200 is superimposed on the fabric FB. With respect to the color of the first area AR1, which is white, and the color of the second area AR2, which is black, correction is made to variation in the appearance of the fabric FB due to variation in the light source as illumination, the position of the illumination, and other factors.

The backing 300 is a backing member used during the imaging. The backing 300 is configured, for example, with a thin metal plate, a synthetic resin sheet, a thick paper sheet. The backing 300 has a quadrangular shape. The backing 300 has a first backing color area BR1 and a second backing color area BR2. The first backing color area BR1 occupies half of one surface of the backing 300. The second backing color area BR2 occupies the other half of the one surface of the backing 300. The color of the first backing color area BR1 is white. The color of the second backing color area BR2 is black. The first backing color area BR1 and the second backing color area BR2 are so arranged in the backing 300 that a boundary B1 between the first backing color area BR1 and the second backing color area BR2 is a linear boundary. The boundary B1 between the first backing color area BR1 and the second backing color area BR2 is also referred to as a “first boundary”.

The fabric FB has a printed area PR, where an image has been printed by textile printing, and a non-printed area NR, where no image has been printed. A rectangular solid image is printed on the fabric FB in black in a device-dependent color space to form the printed area PR. The rectangular solid image may be printed with black ink, light black ink, or the combination of cyan ink, magenta ink, and yellow ink. The light black ink is low-density black ink. The printed area PR is so disposed on the fabric FB that at least a portion of the printed area PR and at least a portion of the non-printed area NR fall within the range viewed through the window OP in the state in which the imaging jig 200 is superimposed on the fabric FB. Since the printed image has a rectangular shape, a boundary B2 between the printed area PR and the non-printed area NR is a linear boundary. The boundary B2 between the printed area PR and the non-printed area NR is also referred to as a “second boundary”.

The image processing apparatus 400 shown in FIG. 1 is, for example, a personal computer. The image processing apparatus 400 generates a texture image by using the image captured by the imager 100. The image processing apparatus 400 includes the memory 410, an interface circuit 420, an input device 430 and a display device 440 coupled to the interface circuit 420, and a CPU 450 as a processor. The imager 100 is further coupled to the interface circuit 420. The image processing apparatus 400 and the imager 100 can communicate with each other. The input device 430 is, for example, a keyboard or a mouse. The display device 440 is, for example, a liquid crystal display or an organic electro-luminescence (EL) display.

The memory 410 stores a program PG. The CPU 450 executes the program PG to realize functions of a correction processor 451, a selector 452, and a clipper 453, which will be described later. The CPU 450 also has the function of imaging a subject by instructing the imager 100 to perform imaging.

The correction processor 451 acquires target image data representing a fabric image inside the window OP in the captured image and comparison image data representing the comparison pattern of the imaging jig 200 in the captured image, and corrects the target image data by using the comparison image data.

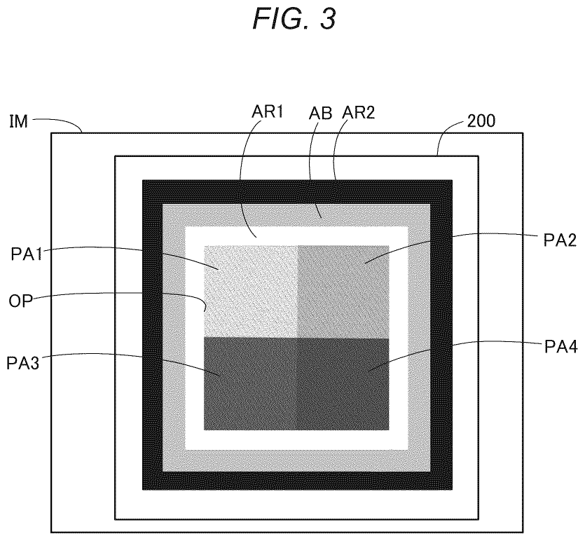

FIG. 3 illustrates an example of the captured image. The selector 452 (see FIG. 1) selects at least one of four partial areas described below. The fabric FB is imaged in the state in which the fabric FB is backed with the backing 300, which has the white first backing color area BR1 and the black second backing color area BR2, as shown in FIG. 2. The following four partial areas therefore fall within the range viewed through the window OP of the imaging jig 200, as shown in FIG. 3:
(i) a first partial area PA1, where the non-printed area NR of the fabric FB is superimposed on the white first backing color area BR1;
(ii) a second partial area PA2, where the non-printed area NR of the fabric FB is superimposed on the black second backing color area BR2;
(iii) a third partial area PA3, where the printed area PR of the fabric FB is superimposed on the white first backing color area BR1; and
(iv) a fourth partial area PA4, where the printed area PR of the fabric FB is superimposed on the black second backing color area BR2.

The clipper 453 shown in FIG. 1 clips the partial area selected by the selector 452 from the captured image to acquire the texture image data.

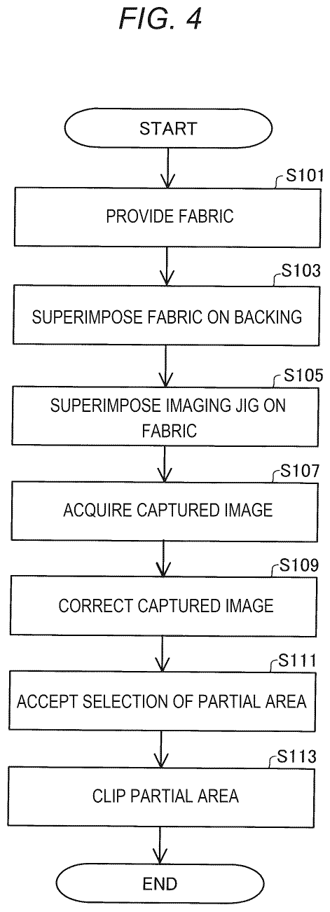

FIG. 4 is a flowchart showing the process of acquiring the texture image data. In step S101, a user provides the fabric FB. The fabric FB has the printed area PR and the non-printed area NR, as described above. The fabric FB to be provided is desirably the same fabric as the print medium or a fabric having a texture close to that of the print medium.

In step S103, the user superimposes the fabric FB on the backing 300. The backing 300 is first placed at a position where the imager 100 can image the backing 300. For example, the backing 300 is placed at the placement table described in the prior application 1, at which the subject is placed. The fabric FB is then superimposed on the backing 300. In this process, the fabric FB is so superimposed on the backing 300 that the fabric FB has the first partial area PA1, the second partial area PA2, the third partial area PA3, and the fourth partial area PA4 described above. More specifically, the fabric FB is so superimposed on the backing 300 that the boundary B2 between the printed area PR and the non-printed area NR of the fabric FB is rotated by 90 degrees with respect to the boundary B1 between the first backing color area BR1 and the second backing color area BR2 of the backing 300, as shown in FIG. 2. The four partial areas can therefore be readily formed.

In step S105, the user superimposes the imaging jig 200 on the fabric FB, as shown in FIG. 4. In this process, the imaging jig 200 is so superimposed on the fabric FB that the first partial area PA1, the second partial area PA2, the third partial area PA3, and the fourth partial area PA4 fall within the range of the window OP of the imaging jig 200.

In step S107, a captured image is acquired by imaging the fabric FB together with the imaging jig 200. Note that the position and posture of the imager 100 with respect to the fabric FB and the imaging jig 200 are so adjusted that the entire imaging jig 200 falls within the imaging range of the imager 100. For example, in response to an operation instruction issued by the user via the input device 430, the CPU 450 of the image processing apparatus 400 instructs the imager 100 to perform the imaging. The imager 100 images the fabric FB, which is the subject, and transmits the captured image representing the image of the fabric FB to the image processing apparatus 400.

In step S109, correction is performed on the captured image. Targets of the correction include distortion of an angle of view, unevenness caused by the illumination, low contrast due to insufficient exposure, defocus, luminance noise, and high-sensitivity noise, which are noise contained in the captured image. When the captured image acquired by the imager 100 is expressed in the RGB color space, the process of converting the captured image into an image in the L*a*b* color space is first carried out. To correct the distortion of the angle of view, affine transformation is applied to the captured image. A method for performing the affine transformation is the same as the method described in the prior application 1. Contrast correction is subsequently applied to the captured image. A method for performing the contrast correction is the same as the method described in the prior application 1.

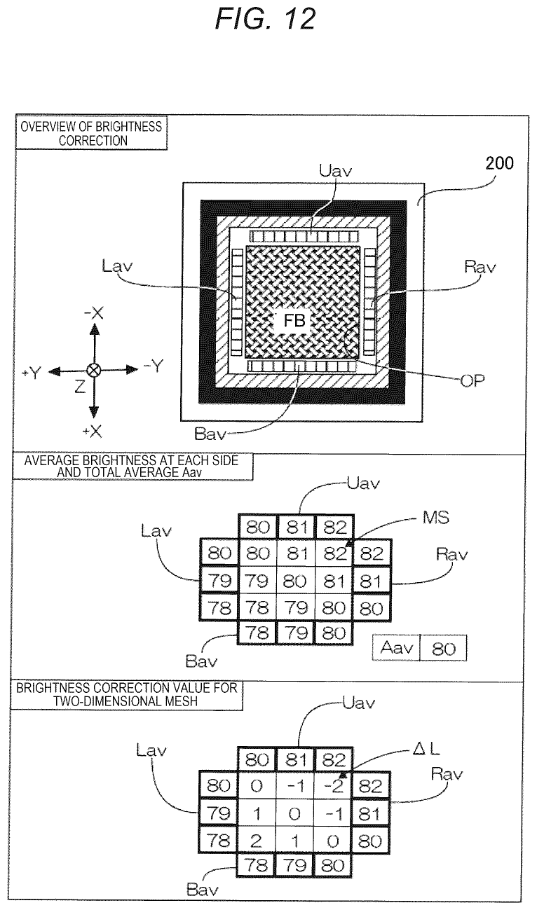

FIG. 12 illustrates brightness correction. In the example shown in FIG. 12, the captured image is disposed in an XY plane. The vertically downward direction is defined as a +Z-axis direction, and the X-axis and the Y-axis are orthogonal to the Z-axis. Furthermore, brightness correction is applied to the captured image. A method for performing the brightness correction using the comparison pattern is the same as the method described in the prior application 1. Note that an image to be subjected to the brightness correction is an image after the distortion of the angle of view is corrected by the affine transformation and the contrast is corrected.

Specifically, the brightness correction can be performed in accordance with a procedure from <1> to <6> below.
<1> The position of the rectangular first area AR1 is identified by edge determination based on the captured image. The positions of pixels in the first area AR1 are expressed by two-dimensional coordinates (x, y).
<2> The average brightness of each of four sides in the first area AR1 is calculated by using brightness L(x, y) at the pixels that constitute the image in the first area AR1. Out of the pixels in the first area AR1, average brightness Uav at the positions of the upper-side pixels, average brightness Rav at the positions of the right-side pixels, average brightness Bav at the positions of the lower-side pixels, and average brightness Lav at the positions of the left-side pixels are determined, as shown in FIG. 12. The average brightness at certain pixel positions (x, y) is expressed, for example, as Uav(x, y).
<3> The average brightness values at the four sides are further averaged to determine a total average Aav.
<4> Based on the average brightness Uav(x, y), Rav(x, y), Bav(x, y), and Lav(x, y) at the four sides, a two-dimensional mesh MS corresponding to the area surrounded by the four sides, that is, all the pixels in the window OP is assumed, and a distribution Lip(x, y) of the brightness L of the mesh MS is determined by interpolation.
<5> A brightness correction value ΔL used to correct brightness Lg(x, y) of a pixel g at a position (x, y) is determined by an expression (1) below.

$$Δ L ( x , y ) = Aav - Lip ( x , y ) \qquad ( 1 )$$

In the expression (1), Lip(x, y) is not the actual brightness of the image in the window OP, but is the distribution of the brightness L determined by the interpolation of the average brightness Uav(x, y), Rav(x, y), Bav(x, y), and Lav(x, y) at the four sides.
<6> The determined brightness correction value ΔL(x, y) is added to the actual brightness L(x, y) of each pixel g(x, y) of the image in the window OP.

The brightness L(x, y) of each pixel g(x, y) is thus corrected.

The brightness correction described above can correct the brightness when the brightness varies from location to location, such as illumination unevenness. An example of determining the brightness correction value ΔL for the two-dimensional mesh will be shown below on the assumption that the size of the window OP is 3×3 pixels. In the middle part of FIG. 12, the average brightness values Uav(x, y), Rav(x, y), Bav(x, y), and Lav(x, y) at the four sides are assumed to be values at 1×3 or 3×1 pixels, and the distribution of the brightness L obtained by performing interpolation thereon is assumed to include brightness values at 3×3 pixels, examples of which are shown by way of example. In practice, the brightness distribution may be calculated in accordance with the number of the pixels of the image in the window OP. In this process, when it is necessary to increase the accuracy of brightness correction, the vertical direction in the case of the average brightness Uav(x, y) and Bav(x, y), which are brightness values at horizontally elongated sides, and the horizontal direction in the case of the average brightness Rav(x, y) and Lav(x, y), which are brightness values at vertically elongated sides, are each called a width direction corresponding to the multiple pixels, and the average of the brightness values of the pixels arranged in the width direction is defined as representative brightness. Specifically, for example, when Uav(x, y) is configured to have brightness values at 10 pixels in the x direction and 100 pixels in the y direction, brightness values L at 1×100 pixels, as a result of averaging the brightness values L at the 10 pixels, are used as the average brightness Uav(x, y).

Furthermore, sharpening or blurring may be applied to the captured image as necessary. A specific method for performing the affine transformation, the contrast correction, the brightness correction, the sharpening, and the blurring described above can be the method described in the prior application 1. The process in step S109 is carried out by the CPU 450 that functions as the correction processor 451.

In step S111, selection of a partial area to be clipped from the fabric image inside the window OP in the captured image is accepted, as shown in FIG. 4. For example, the display device 440 displays a GUI that is not shown but accepts the selection of a partial area. The user uses the input device to select at least one partial area. The process in step S111 is carried out by the CPU 450 that functions as the selector 452.

In step S113, the selected partial area is clipped from the fabric image inside the window OP in the captured image. Texture image data TI, which is image data representing the clipped partial area, is saved, for example, in the memory 410. The process in step S113 is carried out by the CPU 450 that functions as the clipper 453. When the partial area is clipped, it is desirable that a peripheral edge that is a boundary between the window and another partial area adjacent to the clipped partial area is not contained in the range to be clipped. This is because it is conceivable that the brightness of the peripheral edge of each of the partial areas is affected by a shadow caused by the thickness of the imaging jig 200.

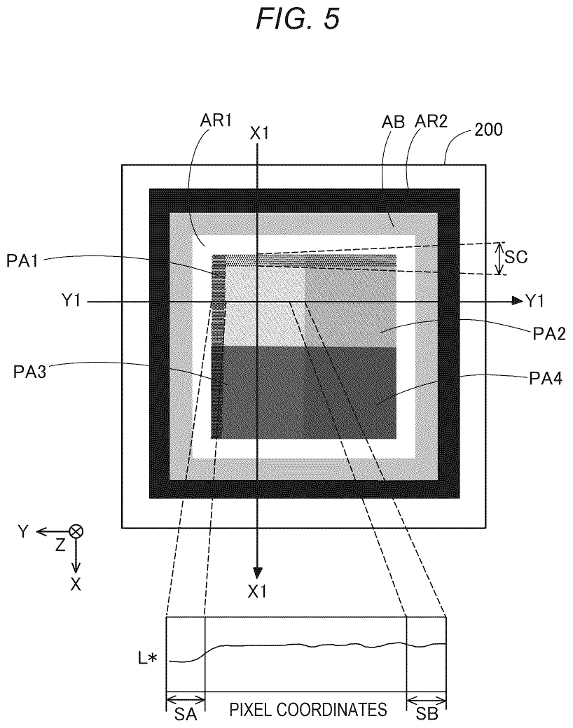

FIG. 5 illustrates a method for identifying the range to be clipped. The captured image is disposed in the XY plane. The vertically downward direction is defined as the +Z-axis direction, and the X-axis and the Y-axis are orthogonal to the Z-axis.

It is assumed that the first partial area PA1 is selected as the target to be clipped. When the brightness L* of each pixel is measured along a line segment Y1-Y1 passing through the center of the first partial area PA1 in the Y-axis direction, a range SA, where the brightness L* slightly decreases in the vicinity of the boundary between the window OP and the +Y side of the first partial area PA1, may be seen, as shown in the lower portion of FIG. 5. The lower portion of FIG. 5 shows a graph of the brightness L* of the pixels along the line segment Y1−Y1. The horizontal axis represents the pixel coordinates, and the vertical axis represents the brightness.

Let P1 be the number of pixels corresponding to the width of the range SA in the Y-axis direction. The pixels corresponding to the number of pixels P1 and arranged from the +Y-side boundary of the first partial area PA1 toward the negative end in the Y direction are excluded from the target to be clipped.

Furthermore, it is assumed that there is influence of the diffusively reflected light from the second partial area PA2 adjacent to the first partial area PA1 and dot gain. Therefore, also in the vicinity of the boundary between the first partial area PA1 and the second partial area PA2, the pixels corresponding to a range SB are excluded from the range to be clipped. For example, the number of pixels corresponding to the width of the range SB in the Y-axis direction is set to be equal to the number of pixels corresponding to the width of the range SA in the Y-axis direction.

Instead, irrespective of the measured values of the brightness L* of the pixels, a predetermined number of pixels from each of the four sides of the first partial area PA1 toward the center thereof may be excluded from the target to be clipped.

In a cross-sectional view of a woven or knit fabric, yarns that constitute the fabric are woven or knit in a periodic shape. It is desirable that the target to be clipped contains at least two cycles of the periodic shape.

When the brightness L* of each pixel is measured along a line segment X1-X1 passing through the center of the first partial area PA1 in the X direction, a range SC, where the brightness L* slightly decreases in the vicinity of the boundary between the window OP and the −X side of the first partial area PA1, may be seen. This range is also desirably excluded from the range to be clipped, as in the case described above. Furthermore, since it is assumed that there is influence of the diffusively reflected light from the third partial area PA3 adjacent to the first partial area PA1 and the dot gain, it is desirable that a portion of the pixels is excluded from the range to be clipped also in the vicinity of the boundary between the first partial area PA1 and the third partial area PA3.

As described above, in the present embodiment, the combination of the printed area and the non-printed area of the fabric FB and the two backing colors allows four types of texture image data to be acquired by performing imaging once.

The four types of acquired texture image data can be used, for example, in the applications below.

The texture image data obtained by clipping the second partial area PA2, where the non-printed area NR of the fabric FB is superimposed on the black second backing color area BR2, can be employed in the method for creating proof image data in JP-A-2024-207035 and JP-A-2024-207036 disclosed by the applicant of the present disclosure. In this case, it is assumed that the texture image data is acquired by using, as the fabric FB, a transparent fabric that is a woven fabric such as chiffon, tulle, organza, georgette, lace, mesh, batiste, and gauze. To create proof image data representing a printed fabric that is a transparent fabric on which an image has been printed, the brightness contained in the texture image data can be used as information on the texture of the transparent fabric.

The texture image data obtained by clipping the fourth partial area PA4, where the printed area PR of the fabric FB is superimposed on the black second backing color area BR2, can be used to create proof image data representing a fabric having high ink absorbability and having a surface showing a state that changes as a result of ink absorption as compared with the state before the ink absorption, such as felt. Specifically, the brightness contained in the texture image data obtained by clipping the range of the fourth partial area PA4 from the captured image is used as the texture information. In this case, it is assumed that texture image data is acquired by using a target fabric as the fabric FB.

The texture image data obtained by clipping the third partial area PA3, where the printed area PR of the fabric FB is superimposed on the white first backing color area BR1, can be used to create proof image data representing a fabric or the like produced by knitting such as a mesh knit fabric. Specifically, the brightness contained in the texture image data obtained by clipping the range of the third partial area PA3 from the captured image is used as the texture information. Note that no texture information is given to an area of a gap between knitted portions of the fabric. In this case, it is assumed that texture image data is acquired by using a target fabric as the fabric FB.

The texture image data obtained by clipping the first partial area PA1, where the non-printed area NR of the fabric FB is superimposed on the white first backing color area BR1, can be used to create proof image data representing a fabric excluding a lace fabric produced by knitting such as the transparent fabric described above, a felt-like fabric, and a mesh knit fabric. Specifically, the brightness contained in the texture image data obtained by clipping the range of the first partial area PA1 from the captured image can be used as the texture information.

### B. Other Embodiments

(B1) The boundaries between the first partial area PA1 to the fourth partial area PA4 adjacent to each other may be detected by edge detection. Instead, a guide marker may be used to detect the boundaries between the first partial area PA1 to the fourth partial area PA4 adjacent to each other.

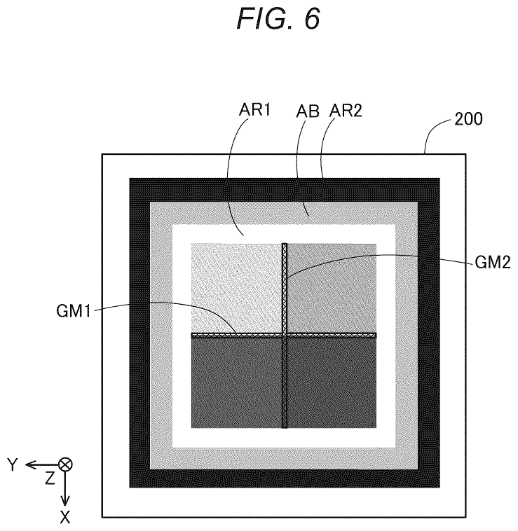

FIG. 6 illustrates the guide marker. In the example shown in FIG. 6, a guide marker GM1 is disposed in the window OP along the Y-axis direction. More specifically, the guide marker GM1 is disposed at the boundary between the first partial area PA1 and the second partial area PA2 and between the third partial area PA3 and the fourth partial area PA4. Furthermore, a guide marker GM2 is disposed in the window OP along the X-axis direction. More specifically, the guide marker GM2 is disposed at the boundary between the first partial area PA1 and the third partial area PA3 and between the second partial area PA2 and the fourth partial area PA4. The guide markers GM1 and GM2 are, for example, rod-shaped members made of resin.

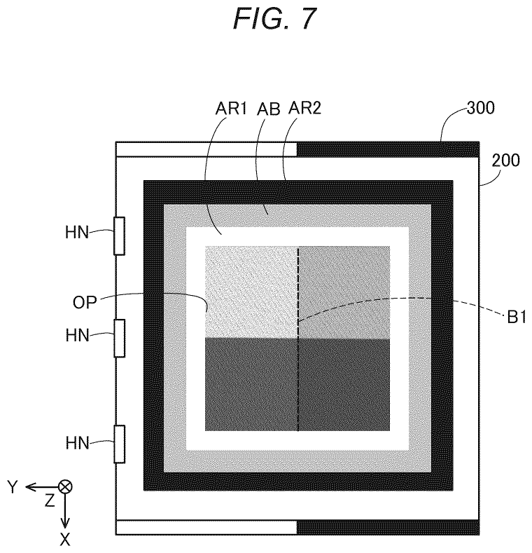

The user visually checks the boundaries between the partial areas and places the guide markers GM1 and GM2 at the boundaries. When the guide markers GM1 and GM2 are placed, the rear side of the backing 300 may be illuminated with light, so that the user can readily recognize the boundary B1 in the backing 300. It should be noted that the rear side of the backing 300 should not be illuminated with light when the fabric FB is imaged. This is because the illumination reduces the reproducibility of the texture of the fabric in the texture image. In the captured image obtained by imaging the fabric FB including the guide markers GM1 and GM2 as in the example shown in FIG. 6, the accuracy of the detection of the boundaries between the partial areas is improved at the time of edge detection for detecting the boundaries between the partial areas, as compared with the aspect in which none of the guide markers GM1 and GM2 is placed. Note that a cross-shaped guide marker that is two rod-shaped members perpendicular to each other and fixed to each other may be used as the guide marker. (B2) FIG. 7 illustrates a configuration in which the imaging jig 200 and the backing 300 are fixed to each other. In the example shown in FIG. 7, the +Y-side end of the backing 300 and the +Y-side end of the imaging jig 200 are fixed to each other via hinges HN. The imaging jig 200 is rotatable around an axis of rotation along the X-axis. In the state in which the imaging jig 200 is superimposed on the backing 300, the position of the backing 300 relative to the position of the imaging jig 200 in the XY plane is so fixed that the +Y-side side and the −Y-side side of the window OP are parallel to the boundary B1 (see FIG. 2) between the first backing color area BR1 and the second backing color area BR2 of the backing 300.

The user superimposes the fabric FB on the backing 300 with the imaging jig 200 rotated so that the imaging jig 200 is lifted from the backing 300. The user superimposes the fabric FB on the backing 300 in a way that the boundary B2 and the printed area PR and the non-printed area NR of the fabric FB is rotated by 90 degrees with respect to the boundary B1 between the first backing color area BR1 and the second backing color area BR2 of the backing 300. The user then rotates the imaging jig 200 in the reverse direction to cause the imaging jig 200 to return to the original position. In the example shown in FIG. 7, since the position of the backing 300 relative to the position of the imaging jig 200 in the XY plane is fixed, positioning in the superposition of the imaging jig 200 on the fabric FB is readily performed.

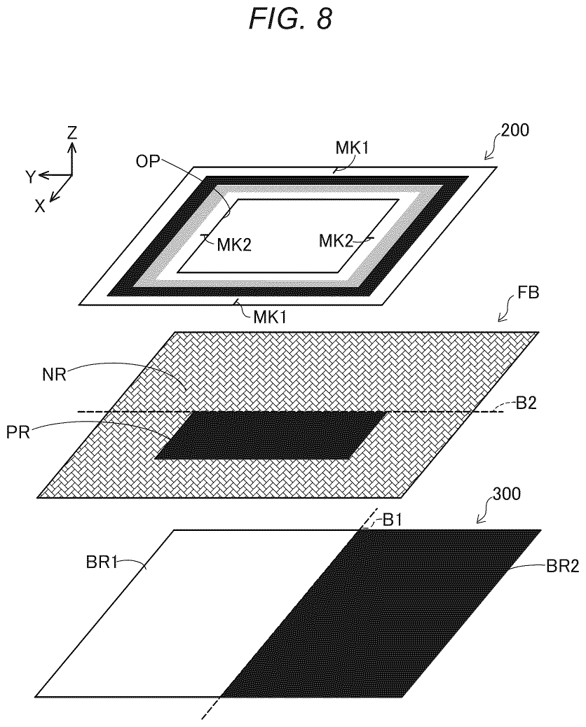

(B3) FIG. 8 illustrates a case where the imaging jig 200 is provided with a positioning mark. The imaging jig 200 is provided with a pair of positioning marks MK1 indicating positions with which the boundary B1 between the first backing color area BR1 and the second backing color area BR2 of the backing 300 is aligned. One of the positioning marks MK1 is disposed at the midpoint of the −X-side side of the imaging jig 200. The other positioning mark MK1 is disposed at the midpoint of the +X-side side of the imaging jig 200.

Furthermore, the imaging jig 200 is provided with a pair of positioning marks MK2 indicating positions with which the boundary B2 between the printed area PR and the non-printed area NR of the fabric FB is aligned. One of the positioning marks MK2 is disposed at the midpoint of the +Y-side side of the window OP. The other positioning mark MK2 is disposed at the midpoint of the −Y-side side of the window OP.

The user can make the size of the printed area PR and the size of the non-printed area NR viewed through the window OP equal to each other only by superimposing the imaging jig 200 on the fabric FB in a way that the boundary B2 of the fabric FB is aligned with the pair of positioning marks MK2.

The user can make the +Y-side side and the −Y-side side of the window OP parallel to the boundary B1 of the backing 300 only by superimposing the imaging jig 200 on the fabric FB in a way that the boundary B1 of the backing 300 is aligned with the pair of positioning marks MK1. It is desirable that the fabric FB is so superimposed on the backing 300 that the boundary B2 and the printed area PR and the non-printed area NR of the fabric FB is rotated by 90 degrees with respect to the boundary B1 between the first backing color area BR1 and the second backing color area BR2 of the backing 300, as described in the above embodiment. In the example shown in FIG. 8, the fabric FB is readily superimposed on the backing 300 with the boundary B1 and the boundary B2 being perpendicular to each other.

(B4) The above embodiments have been described with reference to the case where the partial areas each have a square shape, and the partial areas may each have a rectangular shape.

(B5) In the embodiments described above, the color of the first backing color area BR1 is white, and the color of the second backing color area BR2 is black. For example, when the third partial area PA3, which is the printed area having a background of the white first backing color area BR1, and the fourth partial area PA4, which is the printed area having a background of the black second backing color area BR2, are selected, increasing the difference in brightness between the backing colors allows acquisition of a texture image showing a clear difference in brightness in comparison between the third partial area PA3 and the fourth partial area PA4. Similarly, for example, when the first partial area PA1, which is the non-printed area having a background of the white first backing color area BR1, and the second partial area PA2, which is the non-printed area having a background of the black second backing color area BR2, are selected, a texture image showing a clear difference in brightness can be acquired in comparison between the first partial area PA1 and the second partial area PA2.

(B6) The above embodiments have been described with reference to the case where the first backing color area BR1 is a white area and the second backing color area BR2 is a black area. However, the first backing color area BR1 and the second backing color area BR2 only need to have different types of shading, and are not limited to white and black areas. Being different in shading means that the L* values differ from each other in the L*a*b* color space.

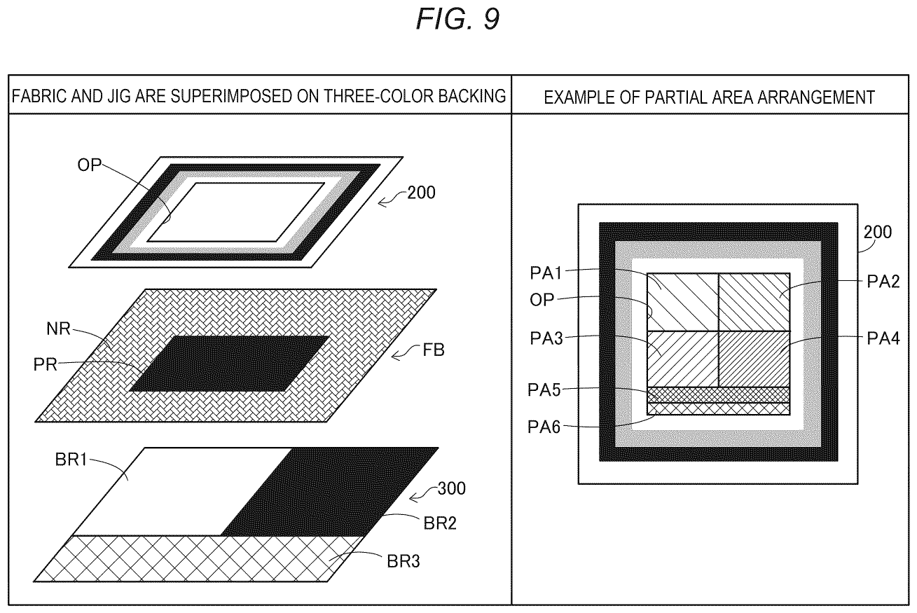

(B7) FIG. 9 illustrates imaging using the backing 300 having three backing color areas. The left portion of FIG. 9 shows a state in which the fabric FB and the imaging jig 200 are superimposed on the backing 300. The right portion of FIG. 9 shows the above state viewed from above, in which the fabric FB and the imaging jig 200 are superimposed on the backing 300. The backing 300 may have a third backing color area BR3 in addition to the first backing color area BR1 and the second backing color area BR2. As the color of the third backing color area BR3, it is desirable to employ a background color assumed when the printed fabric is actually observed.

The six partial areas described below fall within the range viewed through the window OP of the imaging jig 200, as shown in the right portion of FIG. 9. Note that the partial areas (i) to (iv) are the same as those in the embodiments described above.
(i) The first partial area PA1, where the non-printed area NR of the fabric FB is superimposed on the white first backing color area BR1.
(ii) The second partial area PA2, where the non-printed area NR of the fabric FB is superimposed on the black second backing color area BR2.
(iii) The third partial area PA3, where the printed area PR of the fabric FB is superimposed on the white first backing color area BR1.
(iv) The fourth partial area PA4, where the printed area PR of the fabric FB is superimposed on the black second backing color area BR2.
(v) A fifth partial area PA5, where the printed area PR of the fabric FB is superimposed on the third backing color area BR3.
(vi) A sixth partial area PA6, where the non-printed area NR of the fabric FB is superimposed on the third backing color area BR3.

The texture image data obtained by clipping the fifth partial area PA5 from the captured image is texture image data obtained by imaging a state in which the background assumed when the printed fabric is actually observed is used as a backing. The texture image data obtained by clipping the sixth partial area PA6 from the captured image is texture image data obtained by imaging a state in which the background assumed when a non-printed fabric is actually observed is used as a backing.

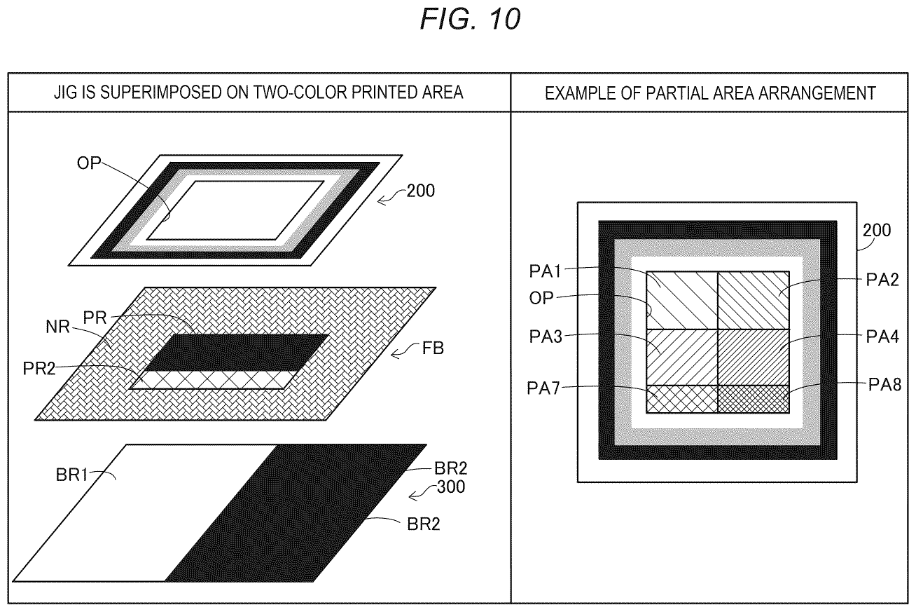

(B8) FIG. 10 illustrates imaging using the fabric FB having two printed areas. The left portion of FIG. 10 shows a state in which the fabric FB and the imaging jig 200 are superimposed on the backing 300. The right portion of FIG. 10 shows the above state viewed from above, in which the fabric FB and the imaging jig 200 are superimposed on the backing 300. The backing 300 having the first backing color area BR1 and the second backing color area BR2 is used, as in the embodiments described above. The fabric FB may have a second printed area PR2, which is another printed area, in addition to the printed area PR. The second printed area PR2 is formed by printing a rectangular solid image on the fabric FB in a color different from black. The second printed area PR2 is desirably formed by using the color of ink actually printed on a fabric to produce the printed fabric.

The six partial areas described below fall within the range viewed through the window OP of the imaging jig 200, as shown in the right portion of FIG. 10. Note that the partial areas (i) to (iv) are the same as those in the embodiments described above.
(i) The first partial area PA1, where the non-printed area NR of the fabric FB is superimposed on the white first backing color area BR1.
(ii) The second partial area PA2, where the non-printed area NR of the fabric FB is superimposed on the black second backing color area BR2.
(iii) The third partial area PA3, where the printed area PR of the fabric FB is superimposed on the white first backing color area BR1.
(iv) The fourth partial area PA4, where the printed area PR of the fabric FB is superimposed on the black second backing color area BR2.
(vii) A seventh partial area PA7, where the second printed area PR2 of the fabric FB is superimposed on the first backing color area BR1.
(viii) An eighth partial area PA8, where the second printed area PR2 of the fabric FB is superimposed on the second backing color area BR2.

The texture image data obtained by clipping the seventh partial area PA7 from the captured image is texture image data obtained by imaging the fabric on which the ink to be actually printed has been printed with a white backing used as the background. The texture image data obtained by clipping the eighth partial area PA8 from the captured image is texture image data obtained by imaging the fabric on which the ink to be actually printed has been printed with a black backing used as the background.

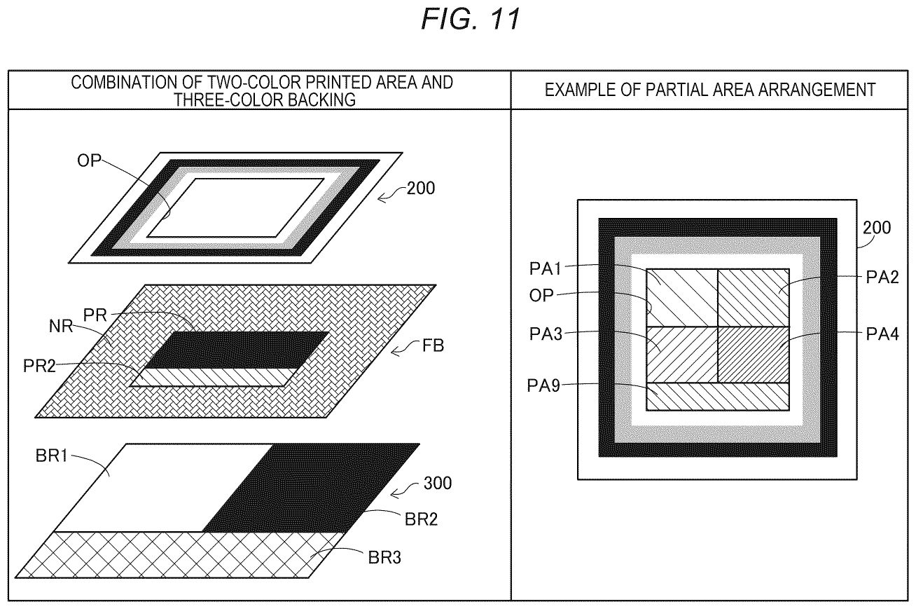

(B9) FIG. 11 illustrates imaging performed using the backing 300 having three backing color areas and the fabric FB having two printed areas. The left portion of FIG. 11 shows a state in which the fabric FB and the imaging jig 200 are superimposed on the backing 300. The right portion of FIG. 11 shows the above state viewed from above, in which the fabric FB and the imaging jig 200 are superimposed on the backing 300. In the example shown in FIG. 11, the backing 300 having the first backing color area BR1, the second backing color area BR2, and the third backing color area BR3, and the fabric FB having the non-printed area NR, the printed area PR, and the second printed area PR2 are used. As the color of the third backing color area BR3, for example, a background color assumed when the printed fabric is actually observed is employed. The second printed area PR2 is formed, for example, by using the color of the ink actually printed on the fabric to produce the printed fabric.

The five partial areas described below fall within the range viewed through the window OP of the imaging jig 200, as shown in the right portion of FIG. 11. Note that the partial areas (i) to (iv) are the same as those in the embodiments described above.
(i) The first partial area PA1, where the non-printed area NR of the fabric FB is superimposed on the white first backing color area BR1.
(ii) The second partial area PA2, where the non-printed area NR of the fabric FB is superimposed on the black second backing color area BR2.
(iii) The third partial area PA3, where the printed area PR of the fabric FB is superimposed on the white first backing color area BR1.
(iv) The fourth partial area PA4, where the printed area PR of the fabric FB is superimposed on the black second backing color area BR2.
(ix) A ninth partial area PA9, where the second printed area PR2 of the fabric FB is superimposed on the third backing color area BR3.

The texture image data obtained by clipping the ninth partial area PA9 from the captured image is texture image data obtained by imaging a state in which a fabric on which the ink to be actually printed has been printed is backed with a background assumed when the printed fabric is actually observed.

(B10) In the settings of printing for forming the printed area PR on the fabric FB, it is desirable that a duty value of the ink is set at a value greater than or equal to a predetermined reference value. The duty value of the ink indicates the amount of the ink per unit area ejected onto a medium. Forming the printed area PR by performing printing with the duty value of the ink being set at a large value allows acquisition of a texture image showing a clear difference in brightness in comparison between the printed area PR and the non-printed area NR. The color of the fabric in which the printed area PR is formed is not limited to black. The color may, for example, be gray on the assumption that the duty value of the ink is set at a value greater than or equal to the predetermined reference value.

The present disclosure is not limited to the embodiments described above, and can be implemented in various configurations without departing from the intent of the present disclosure. For example, technical features in the embodiments corresponding to technical features in the aspects described in the summary of the disclosure can be replaced or combined as appropriate to solve a part or all of the problems described above or to achieve a part or all of the advantages described above. Any of the technical features can be deleted as appropriate unless described as essential in the present specification.

### C. Other Aspects

(1) According to a first aspect of the present disclosure, a texture image acquisition method is provided. The texture image acquisition method includes: (a) providing an imaging jig having a window through which light passes, and a backing having at least a first backing color area and a second backing color area; (b) providing a fabric having a printed area where ink is printed, and a non-printed area where the ink is not printed; (c) superimposing the fabric on the backing in a way that four partial areas below are provided, (i) a first partial area where the first backing color area of the backing and the non-printed area of the fabric are superimposed on each other, (ii) a second partial area where the second backing color area of the backing and the non-printed area of the fabric are superimposed on each other, (iii) a third partial area where the first backing color area of the backing and the printed area of the fabric are superimposed on each other, and (iv) a fourth partial area where the second backing color area of the backing and the printed area of the fabric are superimposed on each other; (d) superimposing the imaging jig on the fabric in a way that the first partial area, the second partial area, the third partial area, and the fourth partial area fall within the window of the imaging jig; (e) after (d) is carried out, imaging the fabric together with the imaging jig to acquire a captured image; (f) selecting at least one of the first partial area, the second partial area, the third partial area, and the fourth partial area as a target to be clipped from a fabric image contained in the captured image; and (g) clipping the selected partial area from the fabric image to acquire texture image data.

According to the aspect described above, the combination of the printed area and the non-printed area of the fabric and the two backing colors allows four types of texture image data to be acquired by performing imaging once.

(2) In the texture image acquisition method according to the aspect described above, the first backing color area may be a white area, and the second backing color area may be a black area.

According to the aspect described above, increasing the difference in brightness between the backing colors allows acquisition of a texture image showing a clear difference in brightness in comparison between the white backing printed area and the black backing printed area.

(3) In the texture image acquisition method according to the aspect described above, a duty value of ink in the printed area of the fabric may be set at a value greater than or equal to a predetermined reference value.

According to the aspect described above, increasing the duty value of the ink in the printed area allows acquisition of a texture image showing a clear difference in brightness in comparison with the non-printed area.

(4) In the texture image acquisition method according to the aspect described above, the printed area of the fabric may be an area printed in black in a device-dependent color space.

(5) In the texture image acquisition method according to the aspect described above, a first boundary that is a boundary between the first backing color area and the second backing color area of the backing may be a linear boundary, a second boundary that is a boundary between the printed area and the non-printed area of the fabric may be a linear boundary, and the fabric may be so superimposed in (c) on the backing that the second boundary is rotated by 90 degrees with respect to the first boundary.

According to the aspect described above, the four partial areas can be readily formed.

(6) In the texture image acquisition method according to the aspect described above, a peripheral edge of the selected partial area may not fall within a range clipped from the fabric image in (g).

According to the aspect described above, the peripheral edge of the partial area is excluded from the target to be clipped because the brightness of the peripheral edge of the partial area may be affected by a shadow due to the thickness of the imaging jig.

(7) In the texture image acquisition method according to the aspect described above, the imaging jig provided with a comparison pattern surrounding the window and having a first area and a second area having different types of shading may be provided in (a).

(8) The texture image acquisition method according to the aspect described above may further include (h) correcting image data representing the fabric image by using comparison image data representing the comparison pattern contained in the captured image, the correcting being carried out after (e) is carried out.

(9) In the texture image acquisition method according to the aspect described above, a target to be corrected in (h) may include at least one of distortion of an angle of view, unevenness caused by illumination, low contrast due to insufficient exposure, defocus, luminance noise, and high-sensitivity noise each of which may occur in (e).

(10) According to a second aspect of the present disclosure, a texture image acquisition apparatus is provided. The texture image acquisition apparatus includes: an imager configured to image a fabric together with an imaging jig to acquire a captured image, the fabric having a printed area where ink is printed and a non-printed area where the ink is not printed together with an imaging jig having a window through which light passes: in a state in which the fabric is superimposed on a backing having at least a first backing color area and a second backing color area in a way that four partial areas below are provided, (i) a first partial area where the first backing color area of the backing and the non-printed area of the fabric are superimposed on each other, (ii) a second partial area where the second backing color area of the backing and the non-printed area of the fabric are superimposed on each other, (iii) a third partial area where the first backing color area of the backing and the printed area of the fabric are superimposed on each other, and (iv) a fourth partial area where the second backing color area of the backing and the printed area of the fabric are superimposed on each other; and in a state in which the imaging jig is superimposed on the fabric in a way that the first partial area, the second partial area, the third partial area, and the fourth partial area fall within the window of the imaging jig; a selector configured to select at least one of the first partial area, the second partial area, the third partial area, and the fourth partial area as a target to be clipped from a fabric image contained in the captured image; and a clipper configured to clip the selected partial area from the fabric image to acquire texture image data.

According to the aspect described above, the combination of the printed area and the non-printed area of the fabric and the two backing colors allows four types of texture image data to be acquired by performing imaging once.

(11) According to a third aspect of the present disclosure, a program that acquires a texture image is provided. A program configured to cause a computer to achieve: the function of imaging a fabric having a printed area where ink is printed and a non-printed area where the ink is not printed together with an imaging jig having a window through which light passes to acquire a captured image in a state in which the fabric is superimposed on a backing including at least a first backing color area and a second backing color area in a way that four partial areas below are provided, (i) a first partial area where the first backing color area of the backing and the non-printed area of the fabric are superimposed on each other, (ii) a second partial area where the second backing color area of the backing and the non-printed area of the fabric are superimposed on each other, (iii) a third partial area where the first backing color area of the backing and the printed area of the fabric are superimposed on each other, and (iv) a fourth partial area where the second backing color area of the backing and the printed area of the fabric are superimposed on each other, and in a state in which the imaging jig is superimposed on the fabric in a way that the first partial area, the second partial area, the third partial area, and the fourth partial area fall within the window of the imaging jig; the function of selecting at least one of the first partial area, the second partial area, the third partial area, and the fourth partial area as a target to be clipped from a fabric image contained in the captured image; and the function of clipping the selected partial area from the fabric image to acquire texture image data.

According to the aspect described above, the combination of the printed area and the non-printed area of the fabric and the two backing colors allows four types of texture image data to be acquired by performing imaging once.

What is claimed is:

1. A texture image acquisition method comprising:
(a) providing an imaging jig having a window through which light passes, and a backing having at least a first backing color area and a second backing color area;
(b) providing a fabric having a printed area where ink is printed, and a non-printed area where the ink is not printed;
(c) superimposing the fabric on the backing in a way that four partial areas below are provided, (i) a first partial area where the first backing color area of the backing and the non-printed area of the fabric are superimposed on each other, (ii) a second partial area where the second backing color area of the backing and the non-printed area of the fabric are superimposed on each other, (iii) a third partial area where the first backing color area of the backing and the printed area of the fabric are superimposed on each other, and (iv) a fourth partial area where the second backing color area of the backing and the printed area of the fabric are superimposed on each other;
(d) superimposing the imaging jig on the fabric in a way that the first partial area, the second partial area, the third partial area, and the fourth partial area fall within the window of the imaging jig;
(e) after (d) is carried out, imaging the fabric together with the imaging jig to acquire a captured image;
(f) selecting at least one of the first partial area, the second partial area, the third partial area, and the fourth partial area as a target to be clipped from a fabric image contained in the captured image; and
(g) clipping the selected partial area from the fabric image to acquire texture image data.

2. The texture image acquisition method according to claim 1,
wherein the first backing color area is a white area, and the second backing color area is a black area.

3. The texture image acquisition method according to claim 2,
wherein a duty value of ink in the printed area of the fabric is set at a value greater than or equal to a predetermined reference value.

4. The texture image acquisition method according to claim 3,
wherein the printed area of the fabric is an area printed in black in a device-dependent color space.

5. The texture image acquisition method according to claim 4,
wherein a first boundary that is a boundary between the first backing color area and the second backing color area of the backing is a linear boundary,
a second boundary that is a boundary between the printed area and the non-printed area of the fabric is a linear boundary, and
the fabric is so superimposed in (c) on the backing that the second boundary is rotated by 90 degrees with respect to the first boundary.

6. The texture image acquisition method according to claim 5,
wherein a peripheral edge of the selected partial area does not fall within a range clipped from the fabric image in (g).

7. The texture image acquisition method according to claim 6,
wherein the imaging jig provided with a comparison pattern surrounding the window and having a first area and a second area having different types of shading is provided in (a).

8. The texture image acquisition method according to claim 7 further comprising
(h) correcting image data representing the fabric image by using comparison image data representing the comparison pattern contained in the captured image, the correcting being carried out after (e) is carried out.

9. The texture image acquisition method according to claim 8,
wherein a target to be corrected in (h) includes at least one of distortion of an angle of view, unevenness caused by illumination, low contrast due to insufficient exposure, defocus, luminance noise, and high-sensitivity noise each of which may occur in (e).

10. A texture image acquisition apparatus comprising:
an imager configured to image a fabric together with an imaging jig to acquire a captured image, the fabric having a printed area where ink is printed and a non-printed area where the ink is not printed together with the imaging jig having a window through which light passes:
in a state in which the fabric is superimposed on a backing having at least a first backing color area and a second backing color area in a way that four partial areas below are provided, (i) a first partial area where the first backing color area of the backing and the non-printed area of the fabric are superimposed on each other, (ii) a second partial area where the second backing color area of the backing and the non-printed area of the fabric are superimposed on each other, (iii) a third partial area where the first backing color area of the backing and the printed area of the fabric are superimposed on each other, and (iv) a fourth partial area where the second backing color area of the backing and the printed area of the fabric are superimposed on each other; and
in a state in which the imaging jig is superimposed on the fabric in a way that the first partial area, the second partial area, the third partial area, and the fourth partial area fall within the window of the imaging jig;
a selector configured to select at least one of the first partial area, the second partial area, the third partial area, and the fourth partial area as a target to be clipped from a fabric image contained in the captured image; and
a clipper configured to clip the selected partial area from the fabric image to acquire texture image data.

11. A program configured to cause a computer to achieve:
the function of imaging a fabric having a printed area where ink is printed and a non-printed area where the ink is not printed together with an imaging jig having a window through which light passes to acquire a captured image in a state in which the fabric is superimposed on a backing including at least a first backing color area and a second backing color area in a way that four partial areas below are provided, (i) a first partial area where the first backing color area of the backing and the non-printed area of the fabric are superimposed on each other, (ii) a second partial area where the second backing color area of the backing and the non-printed area of the fabric are superimposed on each other, (iii) a third partial area where the first backing color area of the backing and the printed area of the fabric are superimposed on each other, and (iv) a fourth partial area where the second backing color area of the backing and the printed area of the fabric are superimposed on each other, and in a state in which the imaging jig is superimposed on the fabric in a way that the first partial area, the second partial area, the third partial area, and the fourth partial area fall within the window of the imaging jig;
the function of selecting at least one of the first partial area, the second partial area, the third partial area, and the fourth partial area as a target to be clipped from a fabric image contained in the captured image; and
the function of clipping the selected partial area from the fabric image to acquire texture image data.
